(19) United States
(12) Patent Application Publication
(10) Pub. No.: US 2012/0134808 A1
(43) Pub. Date: May 31, 2012

(54) WIND TURBINE OIL LUBRICATION PUMP

(76) Inventor: Mikael Lindberg, Karlstad (SE)

(21) Appl. No.: 13/311,650

(22) Filed: Dec. 6, 2011

(51) Int. Cl. F03D 11/02

(52) U.S. Cl. 416/1; 416/170 R

(57) ABSTRACT

According to the present disclosure, a pressurization system for use in a wind turbine, the wind turbine including at least one rotor blade to capture wind energy and a shaft for transferring the wind energy to a generator is provided. The pressurization system includes at least one pressurizer that is adapted to be powered by the kinetic energy of the shaft and to provide a pressurized fluid to at least one hydrostatic bearing.

### BACKGROUND OF THE INVENTION

The subject matter described herein relates generally to methods and systems for wind turbines, and more particularly, to methods and systems concerning the lubrication system, even more particularly, the fluid lubrication system of one or more bearings of a wind turbine.

Wind energy harvested, for example, through the use of large scale wind turbines has experienced rapid growth in recent years. Sources of this growth may be the numerous environmental, technical and economic benefits related to wind generated energy production. Wind energy is widely available, renewable and reduces the production of greenhouse gases by diminishing. the need of fossil fuels as energy source. Furthermore, technical developments have improved design, manufacturing technologies, materials and power electronic devices of wind turbines and will in the future continue to decrease production costs of wind turbines while increasing their energy production capabilities and efficiencies.

At least some known wind turbines include a tower and a nacelle mounted on the tower. A rotor is rotatably mounted to the nacelle and is coupled to a generator by a shaft. A plurality of blades extend from the rotor. The blades are oriented such that wind passing over the blades turns the rotor and rotates the shaft, thereby driving the generator to generate electricity.

In some known wind turbines, the nacelle of a wind turbine contains many power electronic devices that enable a controlled and efficient conversion of wind energy into electrical energy such as, for example, generator, control, support and cooling systems. The generator is sometimes, but not always, rotationally coupled to the rotor through a gearbox. The gearbox steps up the inherently low rotational speed of the rotor for the generator to efficiently convert the rotational mechanical energy to electrical energy, which is fed into a utility grid via at least one electrical connection. Gearless direct drive wind turbines also exist. The rotor, generator, gearbox and other components are typically mounted within a housing, or nacelle, that is positioned on top of a base that may be a truss or tubular tower.

Generally, the main shaft in the nacelle of a wind turbine transmits primary loads to the wind turbine generator system. Primary loads may be defined as loads that directly affect the generator system through wind energy that is transmitted from the rotor via the main shaft. Typically, apart from the torsion force necessary for harvesting wind energy, the generator system that may include main shaft, gearbox and one or more bearings is exposed to and must absorb or withstand other forces such as, for example, shear forces or bending moments from directional changes of the wind. These forces or loads are usually absorbed by one or more bearings including, for example, a rotor bearing. Often bearings are positioned to absorb loads in front of fragile components such as, for example, in front of the gear box.

Typically, wind turbines in the art use conventional roller bearings. The advantages of such bearings are that they may operate with high loads and at different rotational speeds with grease or oil lubrication, independent of external power for circulation of the lubricant. However, they may require a large amount of space and may be prone to fatigue failure over time, which may be accelerated due to excessive wear on rolling elements, rings and cages, for example, resulting from excessive loads, tight shaft and/or housing fits, improper preloading and brinelling. Further, conventional ball bearings are often relatively noisy.

The use of hydrostatic bearings in wind turbines is desired since they have infinite life duration due to the absence of mechanical contacts. Further, hydrostatic bearings operate under very little friction with very little wear and typically are self-aligning to allow for variations in, for example, shaft alignment both initially and due to loading, pitching and yawing movements during operation of a wind turbine. However, so far hydrostatic bearings have not been used in wind turbines. The reasons for this being as follows: hydrostatic bearings normally require a pressurized fluid flow to build the lubrication film (hydrodynamic film) between bearing and shaft. The pressure necessary for pressurizing and providing the fluid flow is often obtained from an external source such as, for example, a pump. However, wind turbines may be subjected to situations where an external power supply is not available. The wind turbine would then be slowed down and it would be idling, which means that the rotor may rotate slowly. Loss of external power would unavoidably stop the pump. Even though, hydrostatic bearings may handle a very limited number of load cycles at low rotational speeds without pressurized fluid flow the hydrostatic bearings would be subjected to non-optimal conditions that may increase the chances of bearing failure.

For this purpose, it will be appreciated that systems and methods to optimize the use of at least one hydrostatic bearing in a wind turbine is desired. Hence, the subject matter described herein pertains to such methods and systems, which optimize and solve various issues that prevented the use of hydrostatic bearings in wind turbines.

### BRIEF DESCRIPTION OF THE INVENTION

In one aspect, a pressurization system for use in a wind turbine, the wind turbine including at least one rotor blade to capture wind energy, a shaft for transferring the wind energy to a generator and at least one hydrostatic bearing, including at least one pressurizer is provided. The pressurizer is adapted to be powered by the kinetic energy of the shaft and to provide a pressurized fluid to the at least one hydrostatic bearing.

In another aspect, a wind turbine including: a nacelle supported by a tower, at least one rotor blade to capture wind energy, a shaft for transferring the wind energy to a generator, at least one hydrostatic bearing and a pressurization system is provided. The pressurization system includes at least one pressurizer that is powered by the rotational energy of the shaft and adapted to provide a pressurized fluid to the at least one hydrostatic bearing.

In yet another aspect, a method for providing a pressurized fluid to at least one hydrostatic bearing of a wind turbine, the wind turbine including a shaft for transferring wind energy to a generator and a pressurization system including at least one pressurizer is provided. The method includes powering the at least one pressurizer with the kinetic energy of the shaft such that a pressurized fluid is provided to the at least one hydrostatic bearing.

Further aspects, advantages and features of the present invention are apparent from the dependent claims, the description and the accompanying drawings.

### BRIEF DESCRIPTION OF THE DRAWINGS

A full and enabling disclosure including the best mode thereof, to one of ordinary skill in the art, is set forth more particularly in the remainder of the specification, including reference to the accompanying figures wherein:

FIG. 1 is a perspective view of an exemplary wind turbine.

FIG. 2 is an enlarged sectional view of a portion of the wind turbine shown in FIG. 1 indicating the position of a pressurization system.

FIG. 3 is schematic view according to embodiments herein of a nacelle showing the pressurization system including a pressurizer.

FIG. 4 is a schematic view according to embodiments herein of a nacelle showing the pressurization system including the pressurizer and an accumulator.

FIG. 5 is a schematic view according to embodiments herein of a nacelle showing the pressurization system including the pressurizer, an accumulator and an auxiliary generator.

FIG. 6 is a schematic view according to embodiments herein of a nacelle showing the pressurization system including the pressurizer, an accumulator, an auxiliary generator and a supervision system.

### DETAILED DESCRIPTION OF THE INVENTION

Reference will now be made in detail to the various embodiments, one or more examples of which are illustrated in each figure. Each example is provided by way of explanation and is not meant as a limitation. For example, features illustrated or described as part of one embodiment can be used on or in conjunction with other embodiments to yield vet further embodiments. It is intended that the present disclosure includes such modifications and variations.

In general, it will be appreciated that providing a reliable power source for maintaining the pressurized fluid flow to at least one hydrostatic bearing in a wind turbine is desired. Hence, the subject matter described herein pertains to methods and systems that enable the aforementioned provision of pressurized fluid flow to at least one hydrostatic bearing, especially, in cases where the wind turbine is not supplied with external power.

As used herein, the term “blade” is intended to be representative of any device that provides a reactive force when in motion relative to a surrounding fluid. As used herein, the term.“wind turbine” is intended to be representative of any device that generates rotational energy from wind energy, and more specifically, converts kinetic energy of wind into mechanical energy. As used herein, the term “wind generator” is intended to be representative of any wind turbine that generates electrical power from rotational energy generated from wind energy, and more specifically, converts mechanical energy converted from kinetic energy of wind to electrical power.

As used herein, the term “hydrostatic bearing” is intended to be representative of any type of externally pressurized fluid bearing (e.g. fluid static bearing). Further, as used herein the term “hydrostatic bearing” is also intended to be representative of any type of fluid-dynamic bearing. The fluid of the hydrostatic bearings may usually be oil, water or gas. Typically, the hydrostatic bearings described herein may, for example, employ flooded or direct lubrication and may be fitted with temperature sensors, proximity probes and load cells. Further, the pads of hydrostatic bearings are usually designed to facilitate easy exchange, for example, through internal jacking features. Furthermore, the hydrostatic bearings are generally adapted for supporting the (main) wind turbine shaft.

As used herein, the term “pressurizer” is intended to be representative of any installation or device that is capable of providing a pressurized fluid to at least one hydrostatic bearing such as, for example, a pump or more specifically a fluid lubrication pump. Further, for example, a hydraulic, electric or mechanical accumulator that is connected to at least one hydrostatic bearing may also be understood as pressurizer in the context of the present application, provided it is able to provide a pressurized fluid.

As used herein, the term “accumulator” is intended to be representative of a hydraulic, mechanical or electric device or installation adapted for temporary storage of energy to provide a pressurized fluid to at least one hydrostatic bearing, for instance, at zero shaft speed. Typically, the accumulator powers the pressurizer in cases where the external power supply to a wind turbine is interrupted or unavailable.

As used herein the term “auxiliary generator” is intended to be representative of a generator, which powers the pressurizer such that pressurized fluid to the at least one hydrostatic bearing is provided. Typically, the auxiliary generator is connected to the main shaft of a wind turbine and converts the rotational energy of the main shaft into electrical energy. Further, the auxiliary generator may also power a supervision system described in more detail herein.

As used herein, the term “supervision system” is intended to be representative of any system that is capable of monitoring specific parameters and detecting malfunctions, for example, of the generator, pressurizer or the at least one hydrostatic bearing. The supervision system may also be able to transmit this information to a control station by means of direct or wireless data transfer. Further, in cases under normal operation of a wind turbine, where the pressurizer or auxiliary generator are not connected to the wind-turbine shaft but where an external power supply is provided, the supervision system may initiate connection of the pressurizer or of the auxiliary generator to the wind-turbine shaft such that they are powered by the kinetic energy of the shaft.

As used herein, the term “pressurization system” is intended to be representative of a system including at least one pressurizer adapted to provide a pressurized fluid to at least one hydrostatic bearing. The pressurization system may further include one or more of the following elements: at least one accumulator, an auxiliary generator for driving the pressurizer, and a supervision system.

As used herein, the term “connecting element” is intended to be representative of an element that mechanically connects either the auxiliary generator or the pressurizer to the shaft, for example, via a drive belt, chain, gears, friction wheel or equivalents. The connecting element may also be representative of the direct connection to the shaft via a shaft coupling.

Processors described herein process information transmitted from a plurality of electrical and electronic devices that may include, without limitation, sensors, actuators, compressors, control systems, supervision systems and/or monitoring devices. Such processors may be physically located in, for example, a control or supervision system, a sensor, a monitoring device, a desktop computer, a laptop computer, a programmable logic controller (PLC) cabinet, and/or a distributed control system (DCS) cabinet. RAM and storage devices store and transfer information and instructions to be executed by the processor(s). RAM and storage devices can also be used to store and provide temporary variables, static (i.e., non-changing) information and instructions, or other intermediate information to the processors during execution of instructions by the processor(s). Instructions that are executed may include, without limitation, wind turbine control system control commands. The execution of sequences of instructions is not limited to any specific combination of hardware circuitry and software instructions.

In the exemplary embodiments, a real-time controller that includes any suitable processor-based or microprocessor-based system, such as a computer system, that includes microcontrollers, reduced instruction set circuits (RISC), application-specific integrated circuits (ASICs), logic circuits, and/or any other circuit or processor that is capable of executing the functions by, for example the supervision system as described herein. In one embodiment, the controller may be a microprocessor that includes read-only memory (ROM) and/or random access memory (RAM), such as, for example, a 32 bit microcomputer with 2 Mbit ROM, and 64 Kbit RAM. As used herein, the term “real-time” refers to outcomes occurring in a substantially short period of time after a change in the inputs affect the outcome, with the time period being a design parameter that may be selected based on the importance of the outcome and/or the capability of the system processing the inputs to generate the outcome.

The embodiments described herein include a pressurization system that is powered by the kinetic energy of an on- or offshore wind turbine's shaft and adapted to provide a pressurized fluid to at least one hydrostatic bearing. In the embodiments described herein, the at least one hydrostatic bearing may be a fluid static or fluid-dynamic bearing. More specifically, the pressurization system is capable of providing a pressurized fluid to at least one hydrostatic bearing when the external power supply of an on- or offshore wind turbine is interrupted by using the idling motion of the on- or offshore wind turbine with typical energy production capabilities from 1 to 6 MW.

The provision of such a reliable pressurization system that functions even when the external power supply to a wind turbine is interrupted now enables the use of hydrostatic bearings in on- or offshore wind turbines. Hydrostatic bearings are favorable, amongst other reasons since they require little space, function with very low friction down to zero speed, are typically very quiet (e.g., have an increased damping effect), have clearances that change less under load (i.e., are “stiffer”) and, in general, operate smoother than conventional rolling-element bearings.

In contrast to conventional roller-bearings, which may deform in high-speed operation due to centripetal forces, hydrostatic bearings typically have a virtually unlimited lifetime and, thus, their use may extend the service-intervals of a wind turbine. Thereby, maintenance costs of wind turbines, especially, in on- or offshore wind farms may be reduced substantially.

In some embodiments herein, a pressurization system is installed in a wind turbine that enables providing a pressurized fluid flow to at least one hydrostatic bearing, wherein the pressurization system is powered by the kinetic energy of the wind-turbine shaft. Hence, wind turbines subjected to failure of conventional roller bearings may be retrofitted in the field with the installation of the pressurization system including at least one hydrostatic bearing disclosed herein.

Generally, the pressurization system includes a pressurizer, which may be any device capable of providing a pressurized fluid, typically, and for the purpose of better illustration in the present embodiments it may be assumed that the pressurizer is a fluid lubrication pump.

Since the pressurizer derives its power from the kinetic energy of the wind-turbine shall it is normally mounted in the nacelle, for instance, in close proximity of the wind-turbine shaft. Further, since the pressurizer may supply at least one hydrostatic bearing with a pressurized fluid via, for example, pressure lines, positioning the pressurizer also in close proximity to the at least one hydrostatic bearing may be desired to minimize the length of pressure lines. Hence, in such cases where the pressurizer provides pressurized fluid to at least two hydrostatic bearings it may be positioned at equidistance from both the bearings.

The pressurizer may be connected mechanically to and powered directly by the rotational force of the wind-turbine shaft. The pressurizer may also be connected energetically to the kinetic energy of the shaft via an auxiliary generator. For instance, the auxiliary generator may be mechanically connected to the wind-turbine shaft, converting kinetic energy into electrical energy, the latter of which then powers the pressurizer. In either embodiment, generally, one could say that the pressurizer is powered by the kinetic energy of the wind-turbine shaft.

Typically, the mechanical connection between the wind-turbine shaft and the pressurizer or the auxiliary generator is via drive belts, chains, gears, friction wheels or equivalents. Further, the pressurizer or auxiliary generator may be connected directly to the main shaft via a shaft coupling.

According to embodiments, during normal operation of a wind turbine the pressurizer may be powered by the normal power supply provided to the wind turbine. Generally, when the power is disconnected or interrupted, the wind turbine will be taken out of production and go into idling mode, slowly turning. In such a case the pressurizer or the auxiliary generator that powers the pressurizer may be powered by the kinetic energy of the wind-turbine shaft. The pressurizer or auxiliary generator would be connected to the shaft, for example, via a suitable gear ratio.

In general, kinetic energy from the shaft may be used to accumulate energy in one or more accumulators. This energy may be excess energy that is not required to power the pressurizer. Accumulated energy would be used to maintain fluid pressure at at least one hydrostatic bearing, for example, during periods of zero shaft speed or in situations where the pressurizer or the auxiliary generator (if any) powering the pressurizer fail. Employed accumulators may generally be any one or more chosen from the following types: hydraulic, mechanic or electric.

Further, for example, hydraulic accumulators may be connected directly and provide a pressurized fluid to at least one hydrostatic bearing. Electric accumulators may, for example, supply the power to the pressurizer, which provides a pressurized fluid to the at least one hydrostatic bearing.

According to embodiments herein, a supervision system may monitor parameters from the pressurizer and possibly from the auxiliary generator and from the at least one hydrostatic bearing. The hydrostatic bearings are usually set-up to include temperature sensors, proximity probes and load cells that provide data to a supervision system. The aforementioned parameters may be computed on site or send hardwired or via a wireless network to a control station. The control station may be situated outside of the wind turbine. Further, one or more control stations may be part of a wind turbine farm that receives data from multiple supervision systems and hence allows monitoring the status and controlling one or more wind turbines.

The supervision system may be powered by the wind turbine's power supply during normal operation of the wind turbine and in cases where the power supply is interrupted or disconnected may be powered by the auxiliary generator or the accumulator. Thereby, uninterrupted supervision and control of the at least one hydrostatic bearing is provided, increasing the reliability of such bearings for use in wind turbines.

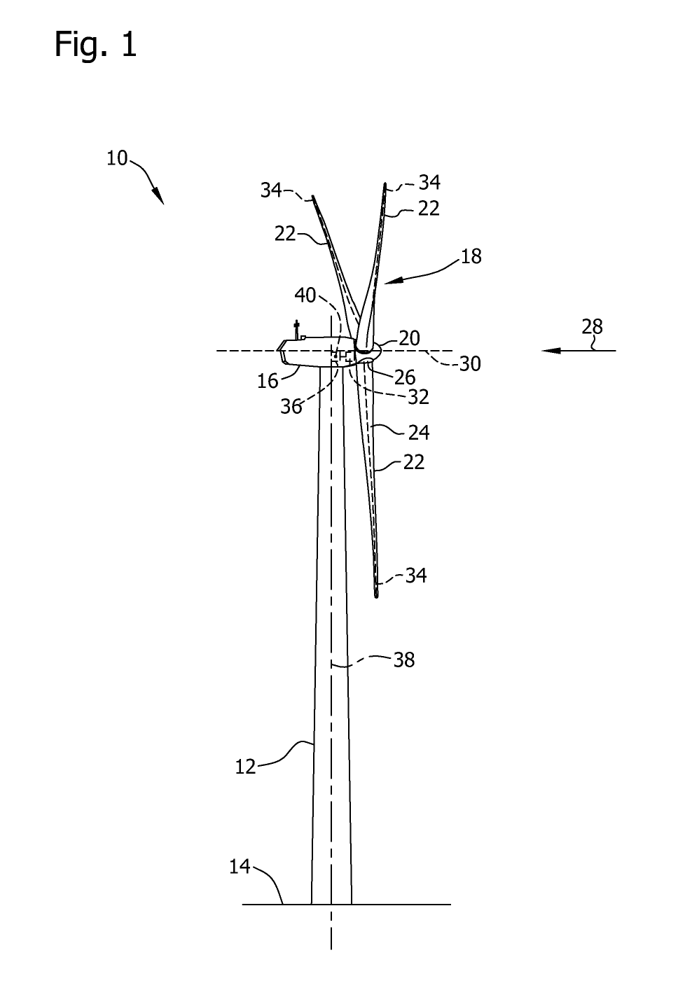

FIG. 1 is a perspective view of an exemplary wind turbine 10. In the exemplary embodiment, wind turbine 10 is a horizontal-axis wind turbine. Alternatively, wind turbine 10 may be a vertical-axis wind turbine. In the exemplary embodiment, wind turbine 10 includes a tower 12 that extends from a support system 14, a nacelle 16 mounted on tower 12, and a rotor 18 that is coupled to nacelle 16. Rotor 18 includes a rotatable hub 20 and at least one rotor blade 22 coupled to and extending outward from hub 20. In the exemplary embodiment, rotor 18 has three rotor blades 22. In an alternative embodiment, rotor 18 includes more or less than three rotor blades 22. In the exemplary embodiment, tower 12 is fabricated from tubular steel to define a cavity (not shown in FIG. 1) between support system 14 and nacelle 16. In an alternative embodiment, tower 12 is any suitable type of tower having any suitable height.

Rotor blades 22 are spaced about hub 20 to facilitate rotating rotor 18 to enable kinetic energy to be transferred from the wind into usable mechanical energy, and subsequently, electrical energy. Rotor blades 22 are mated to hub 20 by coupling a blade root portion 24 to hub 20 at a plurality of load transfer regions 26. Load transfer regions 26 have a hub load transfer region and a blade load transfer region (both not shown in FIG. 1). Loads induced to rotor blades 22 are transferred to hub 20 via load transfer regions 26.

In one embodiment, rotor blades 22 have a length ranging from about 15 meters (m) to about 91 m. Alternatively, rotor blades 22 may have any suitable length that enables wind turbine 10 to function as described herein. For example, other non-limiting examples of blade lengths include 10 m or less, 20 m, 37 m, or a length that is greater than 91 m. As wind strikes rotor blades 22 from a direction 28, rotor 18 is rotated about an axis of rotation 30. As rotor blades 22 are rotated and subjected to centrifugal forces, rotor blades 22 are also subjected to various forces and moments. As such, rotor blades 22 may deflect and/or rotate from a neutral, or non-deflected, position to a deflected position.

Moreover, a pitch angle or blade pitch of rotor blades 22, i.e., an angle that determines a perspective of rotor blades 22 with respect to direction 28 of the wind, may be changed by a pitch adjustment system 32 to control the load and power generated by wind turbine 10 by adjusting an angular position of at least one rotor blade 22 relative to wind vectors. Pitch axes 34 for rotor blades 22 are shown. During operation of wind turbine 10, pitch adjustment system 32 may change a blade pitch of rotor blades 22 such that rotor blades 22 are moved to a feathered position, such that the perspective of at least one rotor blade 22 relative to wind vectors provides a minimal surface area of rotor blade 22 to be oriented towards the wind vectors, which facilitates reducing a rotational speed of rotor 18 and/or facilitates a stall of rotor 18.

In the exemplary embodiment, a blade pitch of each rotor blade 22 is controlled individually by a control system 36. Alternatively, the blade pitch for all rotor blades 22 may be controlled simultaneously by control system 36. Further, in the exemplary embodiment, as direction 28 changes, a yaw direction of nacelle 16 may be controlled about a yaw axis 38 to position rotor blades 22 with respect to direction 28.

In the exemplary embodiment, control system 36 is shown as being centralized within nacelle 16, however, control system 36 may be a distributed system throughout wind turbine 10, on support system 14, within a wind farm, and/or at a remote control center. Control system 36 includes a processor 40 configured to perform the methods and/or steps described herein. Further, many of the other components described herein include a processor. As used herein, the term “processor” is not limited to integrated circuits referred to in the art as a computer, but broadly refers to a controller, a microcontroller, a microcomputer, a programmable logic controller (PLC), an application specific integrated circuit, and other programmable circuits, and these terms are used interchangeably herein. It should be understood that a processor and/or a control or supervision system can also include memory, input channels, and/or output channels.

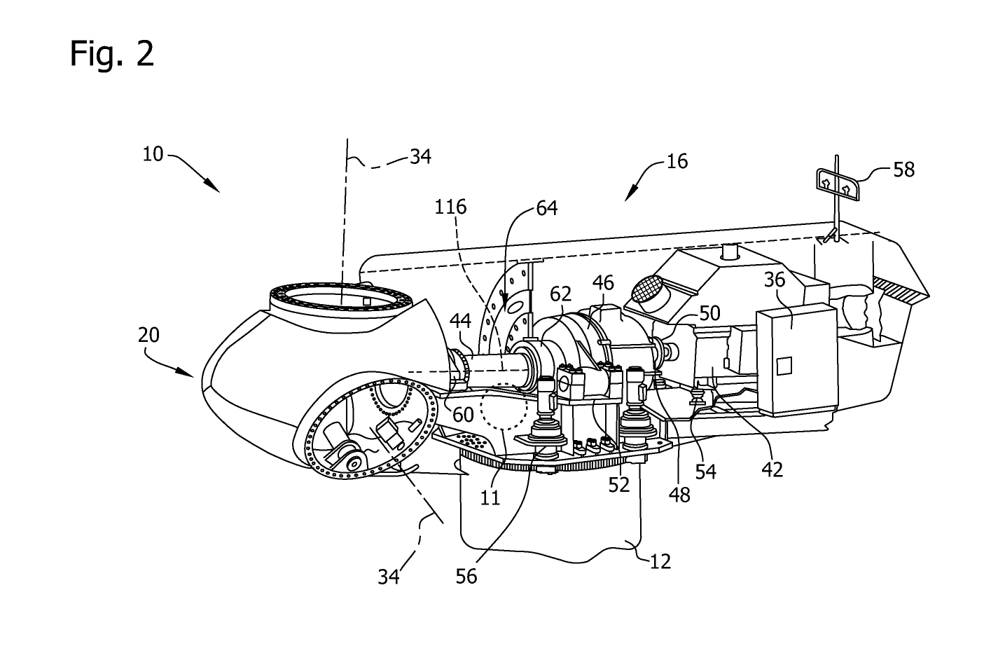

FIG. 2 is an enlarged sectional view of a portion of wind turbine 10 including pressurization system 11. In the exemplary embodiment, wind turbine 10 further includes nacelle 16 and hub 20 that is rotatably coupled to nacelle 16. More specifically, hub 20 is rotatably coupled to an electric generator 42 positioned within nacelle 16 by rotor shaft 44 (sometimes referred to as either a main shaft or a low speed shaft), a gearbox 46, a high speed shaft 48, and a coupling 50. In the exemplary embodiment, rotor shaft 44 is disposed coaxial to longitudinal axis 116. Rotation of rotor shaft 44 rotatably drives gearbox 46 that subsequently drives high speed shaft 48. High speed shaft 48 rotatably drives generator 42 with coupling 50 and rotation of high speed shaft 48 facilitates production of electrical power by generator 42. Gearbox 46 and generator 42 are supported by a support 52 and a support 54. In the exemplary embodiment, gearbox 46 utilizes a dual path geometry to drive high speed shaft 48. Alternatively, rotor shaft 44 is coupled directly to generator 42 with coupling 50.

Nacelle 16 also includes a yaw drive mechanism 56 that may be used to rotate nacelle 16 and hub 20 on yaw axis 38 (shown in FIG. 1) to control the perspective of rotor blades 22 with respect to direction 28 of the wind. Nacelle 16 also includes at least one meteorological mast 58 that includes a wind vane and anemometer (neither shown in FIG. 2). Mast 58 provides information to control system 36 that may include wind direction and/or wind speed. In the exemplary embodiment, nacelle 16 also includes a main forward support bearing 60 and a main aft support bearing 62.

Forward support bearing 60 and aft support bearing 62 facilitate radial support and alignment of rotor shaft 44. Forward support bearing 60 is coupled to rotor shaft 44 near hub 20. Aft support bearing 62 is positioned on rotor shaft 44 near gearbox 46 and/or generator 42. Alternatively, nacelle 16 includes any number of support bearings that enable wind turbine 10 to function as disclosed herein. Rotor shaft 44, generator 42, gearbox 46, high speed shaft 48, coupling 50, and any associated fastening, support, and/or securing device including, but not limited to, support 52 and/or support 54, and forward support bearing 60 and all support bearing 62, are sometimes referred to as a drive train 64.

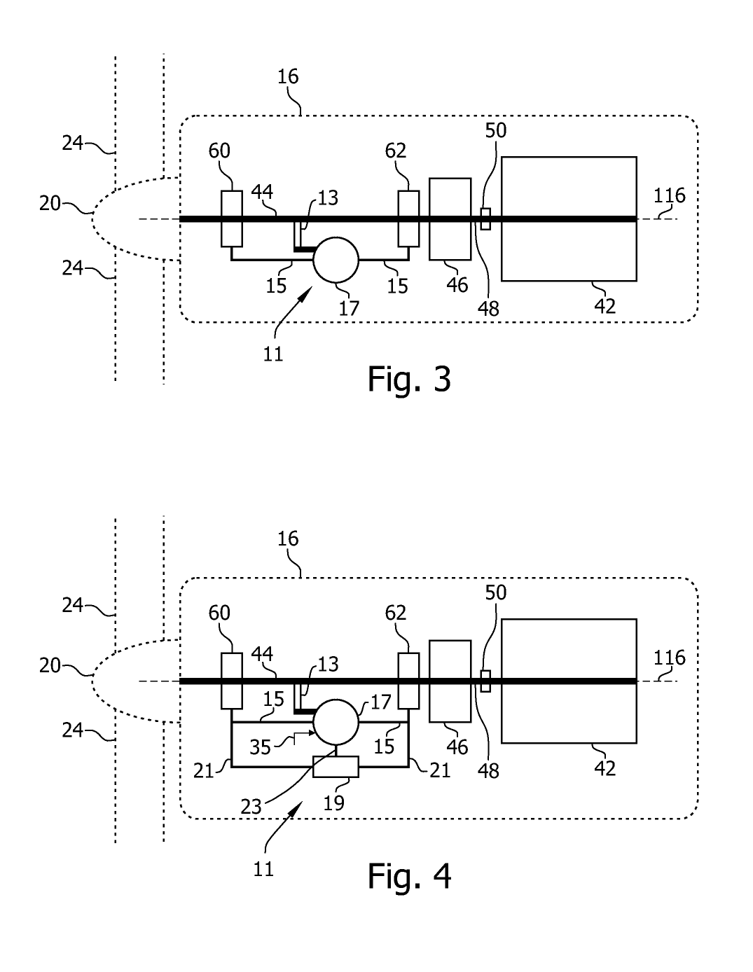

According to embodiments herein, FIG. 3 shows the nacelle 16 of a wind turbine, for instance, of wind turbine 10 as shown in FIG. 1 with a pressurization system 11 that includes only a pressurizer. Forward support bearing 60 and aft support bearing 62 are shown to surround rotor shaft 44. Not limited to any one particular embodiment described herein, bearings 60 and 62 may be hydrostatic bearings that include easily exchangeable bearing pads, for example, by the use of internal jacking features. In particular, loads are transmitted from the blades root portion 24 to the rotatable hub 20 and to shaft 44. Further, shaft 44 transmits the wind energy captured by rotor blades 22 (shown in FIG. 1) to generator 42 via gearbox 46 and shaft coupling 50. For instance, only one hydrostatic bearing may be supporting the wind turbine's shaft, which may be connected to a pressurization system. Further, a pressurization system may be connected to only one of two or more hydrostatic bearings or connected to a number of hydrostatic bearings that is less than the number of hydrostatic bearings installed in the nacelle of a wind turbine.

Further, FIG. 3 further shows pressurizer 17, which may be an oil lubrication pump connected to shaft 44 via connecting element 13 according to embodiments herein. The rotational movement around the longitudinal axis 116 of shaft 44 directly powers pressurizer 17, which provides a pressurized fluid to hydrostatic bearings 60 and 62 via fluid lines 15. Not limited to any particular embodiment described herein fluid lines may include one or more filters to remove any impurities from the circulating pressurized fluid.

According to embodiments herein, FIG. 4 shows a similar configuration of nacelle 16 as illustrated in FIG. 3, described above. However, FIG. 4 further shows an accumulator 19 connected to pressurizer 17. Accumulator 19 may be a hydraulic accumulator (e.g., a hydro-pneumatic accumulator) in which energy is stored. In some embodiments, accumulator 19 may be connected directly to hydrostatic bearing 60 and 62 via fluid lines 21. Hence, providing a pressurized fluid directly to the hydrostatic bearings 60, 62, thereby, for example, the pump may not need to be so large to cope with extremes of demand. Further, additional fluid such as oil may be provided to pressurizer 17 from a fluid reservoir via fluid inlet 35. Furthermore, the accumulator may be charged by pressurizer 17.

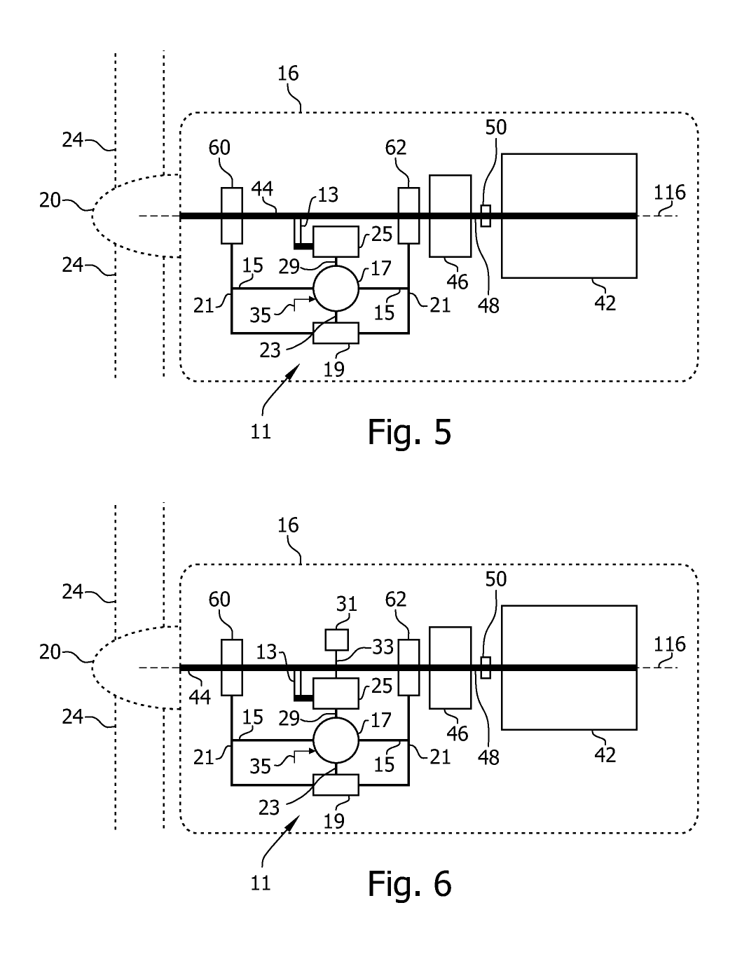

FIG. 5 shows pressurization system 11 according to embodiments described herein, which further includes an auxiliary generator 25. Connecting element 13 mechanically connects auxiliary generator 25 to shaft 44. Thereby, the kinetic energy of shaft 44 powers the auxiliary generator 25, which powers pressurizer 17 via line 29. Accumulator 19 may store excess energy in the form, for example, of a pressurized fluid, which may be provided to pressurizer 17 via line 23 or to the at least one hydrostatic bearing 60, 62 via fluid lines 21. Further, FIG. 5 shows that extra fluid may be provided to pressurizer 17 from fluid inlet 35, which may usually be connected to a fluid reservoir.

In order to store excess electrical energy generated by auxiliary generator 25, an accumulator may be connected directly to auxiliary generator 25 (not shown in the FIGS.). The accumulator may then power pressurizer 17 with, for example, the stored electrical energy, which originated from the kinetic energy of shaft 44. Not limited to any particular embodiment one or more accumulators may be used that store the kinetic energy from shaft 44 either hydraulically, electrically or mechanically. Similarly, the accumulators may power either the pressurizer directly or may provide pressurized fluid to both the pressurizer and at least one hydrostatic bearing.

FIG. 6 shows pressurization system 11 according to embodiments described herein, which further includes a supervision system 31. Supervision system 31 may be connected to and powered by auxiliary generator 25 via line 33. Further, supervision system 31 may also be powered by an accumulator which provides the stored excess energy from the kinetic energy of wind-turbine shaft 44 in situations when the normal power supply to the wind turbine is interrupted (not shown in the FIGS.).

During normal operation of the wind turbine and when it is connected to a power supply, supervision system 31 may be powered by the same power supply (not shown in the FIGS.). Further, supervision system 31 may monitor parameters from any or more of the at least one hydrostatic bearing 60, 62, the auxiliary generator 25, the pressurizer 17, the accumulator and other power electronic devices inside of nacelle 16. The collected data may either be processed directly on site by supervision system 31 or may be sent via a hardwired connection or a wireless network to a control station for further processing, monitoring and controlling purposes. Furthermore, supervision system 31 may initiate an autonomous response, for example, to stop the idling motion of a wind turbine when a hardware defect (e.g., of the at least one hydrostatic bearing) is detected.

According to embodiments described herein, a method for providing a pressurized fluid to at least one hydrostatic bearing of a wind turbine is provided. Usually, a wind turbine, for example, including a shaft and a pressurization system that includes at least one pressurizer is provided. The method includes powering the at least one pressurizer with the kinetic energy of the shaft such that a pressurized fluid is provided to the at least one hydrostatic bearing. Typically, as opposed to wind turbines manufactured with at least one hydrostatic bearing including the pressurization system as described herein, wind turbines in the field will need an exchange on site, for example, of conventional ball bearings for at least one hydrostatic bearing, expressed more generally, will need installation of the pressurization system before the aforementioned method may be employed. Further steps included in the method optionally may be accumulating energy from the shaft to provide a pressurized fluid to the at least one hydrostatic bearing, pumping the fluid with variable pressure into the one or more bearings and transferring data of the pressurization system including, for example, data from the pressurizer, auxiliary generator and accumulator to a control station. The transfer of data may be via a hardwire connection or via a wireless network.

The above-described systems and methods enable and favor the use of hydrostatic bearings in wind turbines. More specifically, by providing a pressurized fluid to at least one hydrostatic bearing, even, in situations where the normal power supply of a wind turbine is interrupted. Additionally, system safety may be increased via a supervision system, which monitors and controls the wind turbine, even, when cut-off from the normal power supply.

Exemplary embodiments of systems and methods for a pressurization system including at least one pressurizer, which is powered by the kinetic energy of a wind-turbine shaft that provides a pressurized fluid to at least one hydrostatic bearing, are described above in detail. The systems and methods are not limited to the specific embodiments described herein, but rather, components of the systems and/or steps of the methods may be utilized independently and separately from other components and/or steps described herein. For example, one or more pressurization system may be employed in other wind turbines, for example vertical wind turbines, other power generating machines or devices with at least one hydrostatic bearing and are not limited to practice with only the wind turbine systems as described herein. Rather, the exemplary embodiment can be implemented and utilized in connection with many other rotor blade applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. While various specific embodiments have been disclosed in the foregoing, those skilled in the art will recognize that the spirit and scope of the claims allows for equally effective modifications. Especially, mutually non-exclusive features of the embodiments described above may be combined with each other. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A pressurization system for use in a wind turbine, the wind turbine including at least one rotor blade to capture wind energy, a shaft for transferring said wind energy to a generator, and at least one hydrostatic bearing, the pressurization system comprising:
at least one pressurizer that is adapted to be powered by the kinetic energy of said shaft and to provide a pressurized fluid to said at least one hydrostatic bearing.

2. The pressurization system according to claim 1, wherein said at least one pressurizer is electrically connected to an auxiliary generator that is connected to said shaft.

3. The pressurization system according to claim 1, further including one or more accumulators adapted for temporary storage of energy to maintain a pressurized fluid to said at least one hydrostatic bearing.

4. The pressurization system according to claim 3, wherein said one or more accumulator is hydraulic, electric or mechanical.

5. The pressurization system according to claim 1, wherein said at least one pressurizer is a pump adapted to provide a pressurized fluid to at least one hydrostatic bearing.

6. The pressurization system according to claim 1, wherein said at least one pressurizer is connected to said shaft by at least one element chosen from the following: a drive belt, chain, gears, and a friction wheel.

7. The pressurization system according to claim 1, wherein said at least one pressurizer is connected to said shaft by a shaft coupling.

8. The pressurization system according to claim 1, further including a supervision system adapted to monitor parameters and detect malfunctions of said at least one pressurizer or of one or more accumulators adapted for temporary storage of energy to maintain a pressurized fluid to said at least one hydrostatic bearing.

9. The pressurization system according to claim 8, wherein said supervision system is powered by an auxiliary generator that is connected to said shaft.

10. A wind turbine, comprising:
a. a nacelle supported by a tower;
b. at least one rotor blade to capture wind energy;
c. a shaft for transferring said wind energy to a generator;
d. at least one hydrostatic bearing; and,
e. a pressurization system that includes at least one pressurizer that is powered by the rotational energy of said shaft and adapted to provide a pressurized fluid to at least one hydrostatic bearing.

11. The wind turbine according to claim 10, wherein said at least one pressurizer is a pump adapted to provide pressurized fluid to said at least one hydrostatic bearing.

12. The wind turbine according to claim 10, further including one or more hydraulic, electric or mechanical accumulators adapted for temporary storage of energy to maintain a pressurized fluid to said at least one hydrostatic bearing.

13. The wind turbine according to claim 10, wherein said at least one pressurizer is mechanically connected to said shaft by a shaft coupling or is mechanically connected to said shaft by at least one element chosen from the following: a drive belt, chain, gears, and a friction wheel.

14. The wind turbine according to claim 10, wherein said at least one hydrostatic bearing is adapted for supporting said shaft.

15. The wind turbine according to claim 10, further including a supervision system adapted to monitor parameters and detect malfunctions of said pressurizer or of one or more hydraulic, electric or mechanical accumulators adapted for temporary storage of energy to maintain a pressurized fluid to said at least one hydrostatic bearing and to transmit data of monitored parameters to a control station.

16. The wind turbine according to claim 15, wherein said supervision system is powered by the rotational energy of said shaft.

17. A method for providing a pressurized fluid to at least one hydrostatic bearing of a wind turbine, the wind turbine including a shaft for transferring wind energy to a generator, and a pressurization system including at least one pressurizer, said method comprising:
powering said at least one pressurizer with the kinetic energy of said shaft such that a pressurized fluid is provided to at least one hydrostatic bearing.

18. The method according to claim 17 and further comprising accumulating energy from said shall to provide a pressurized fluid to said at least one hydrostatic bearing.

19. The method according to claim 18 and further comprising pumping said fluid at variable pressure into said at least one hydrostatic bearing.

20. The method according to claim 17 and further comprising transferring data of said pressurization system to a control station.
